(19) United States
(12) Patent Application Publication
(10) Pub. No.: US 2002/0071418 A1
(43) Pub. Date: Jun. 13, 2002

(54) Method enabling mobility of a wireless therminal in a local area network conforming to the IEEE 802.1Q standard, and a radio interface device for implementing the method

(75) Inventors: Vincent Gouret, Strasbourg (FR); Jean-Michel Lauriol, Fegersheim (FR)

Correspondence Address: SUGHRUE, MION, ZINN, MACPEAK & SEAS, PLLC, 2100 Pennsylvania Avenue, N.W., Suite 800, Washington, DC, 20037-3213, US

(73) Assignee: ALCATEL

(21) Appl. No.: 09/994,643

(22) Filed: Nov. 28, 2001

(30) Foreign Application Priority Data
Dec. 12, 2000 (FR) 00 16 187
Jan. 15, 2001 (FR) 01 00 467

(51) Int. Cl. H04Q 7/24

(52) U.S. Cl. 370/338; 370/349; 370/352

(57) ABSTRACT

The method consists in:

configuring in accordance with the IEEE 802.1Q standard:

all switch ports that are connected to radio access points;

each switch port that is used for a switch-switch or switch-router connection; and

the interface of the router connected to the switch;

configuring the switches to operate in virtual networks using Internet addresses;

setting up a link between the local area network and a mobile terminal via a switch port and via a radio access point connected to said port;

setting up a link between the local area network and a mobile terminal via a switch port and via a radio access point connected to said port; and

writing a virtual network identifier in accordance with the IEEE 802.1Q standard in the header of each frame sent by said mobile terminal to the local area network.

Application to local area networks including wireless terminals.

The invention relates to a method enabling mobility of a wireless terminal in a local area network conforming to the IEEE 802.1Q standard, and a radio interface device for implementing the method.

### BACKGROUND OF THE INVENTION

The above standard covers the design, use and administration of a local area network consisting of plurality of logical subnetworks referred to as virtual local area networks (VLAN). The logical subnetworks can use different technologies (Ethernet, Token Ring, etc.) and are interconnected by bridges. Routers are used to set up connections between terminals belonging to any physical subnetworks.

The invention relates more particularly to local area networks using the Internet Protocol for routing, the Ethernet, Token Ring, etc. protocol being used for the connections.

A local area network subdivided into a plurality of virtual networks enables groups of terminals to be defined that can exchange data between them, regardless of the physical architecture of the network, and can restrict or prohibit the exchange of data between terminals belonging to different groups, for security reasons. To use virtual networks, a bridge must be able to distinguish to which virtual network each frame that it receives belongs.

The IEEE 802.3 standard defines a format with which these virtual networks cannot be distinguished explicitly. The IEEE 802.1Q standard is an extension of the foregoing standard that defines a labeled frame for distinguishing a plurality of virtual networks explicitly. In each frame, a “frame type” field (to be more precise a “length/type” field) indicates if that frame is labeled or not. If it is labeled, a “label” field contains a twelve-bit number that identifies a virtual network explicitly. The 802.1Q standard prohibits a router or a switch from sending frames of two types over the same network segment for the same virtual network. According to the standard, the ports of a router or of a switch can be configured individually so that they label the frames belonging to a given virtual network. A router conforming to the IEEE 802.1Q standard can send on the same link frames belonging to different virtual networks.

There are three prior art methods of defining the virtual network to which a frame belongs:

a method based on the identity of the port that receives the frame;

a method based on the physical address of the terminal that sent the frame (medium access control address of the Ethernet, Token Ring, etc. protocol);

a method based on the home Internet address, which each frame contains and constitutes the logical address of the terminal that sent the frame (all the terminals belonging to the same logical network have respective Internet addresses that include a number of identical bits that identify the subnetwork for the purposes of routing operations).

Using the above three methods, the virtual network to which a frame belongs can be determined on the basis of logical rules, that is to say by reading a label inserted into the frame and containing an explicit virtual network identifier.

FIG. 1 shows diagrammatically one example of a prior art local area network in which two virtual local area networks are distinguished by the Internet addresses of the terminals. The network includes:

two Ethernet switches SW1 and SW2 interconnected by an IEEE 802.1Q link so that terminals on either side, but belonging to the same virtual network, can communicate;

a wired terminal T1 connected to a port no.1 of the switch SW1;

two wired terminals T2 and T3 connected by a bus to a port no.2 of the switch SW1;

a wired terminal T4 connected to a port no.3 of the switch SW1;

a wired terminal T5 connected to a port no.1 of the switch SW2;

a wired terminal T6 connected to a port no.2 of the switch SW2; and

two wired terminals T7 and T8 connected by a bus to a port no.3 of the switch SW2.

In this example, a virtual network VLAN1 is identified by the binary word 192.168.1 that constitutes the first three bytes of the Internet address of each of the terminals T1, T3, T5, T6. A virtual network VLAN2 is identified by the binary word 192.168.2 and by the binary word 192.168.3 that respectively constitute the first three bytes of the Internet address of each of the terminals T2, T4 and T7, T8. These two different binary words correspond to two different logical subnetworks. The Internet addresses of the terminals differ from each other in the fourth and final byte. The port no.2 of the switch SW1 must conform to the IEEE 802.1Q standard to be able to communicate with the terminals T2 and T3 belonging to two different virtual networks.

It may be necessary to move a terminal physically without changing the virtual network to which it belongs. In this case the wire connection of the terminal is disconnected and the terminal is moved and then reconnected. The process of identifying the virtual network continues to function without it being necessary to reconfigure the terminal that has been moved or the switches, because in this network the virtual network to which frames belong is determined from the Internet address of the terminal that sent the frame.

Nowadays, there is increasing use of mobile terminals connected by radio to fixed transceivers, known as access points, connected to a local area network. There are also wireless network interface cards for connecting terminals to a local area network by radio, the terminals being portable computers, for example, that were previously connected to a local area network by a wire connection. It therefore happens more frequently that a terminal is disconnected from one segment of the local area network and then reconnected to another segment of the local area network. It is desirable to be able to divide a local area network further into a plurality of virtual networks. The problem therefore arises of enabling the mobile terminals to change radio access point without changing the virtual network to which they belong or their home Internet address.

When a radio link is used, it is not possible to apply directly the prior art methods of distinguishing the virtual network to which each terminal belongs. Prior art radio access points implement the IEEE 802.1Q standard only partially. In particular, they transmit Ethernet frames without modifying the header fields relating to that standard, i.e. the frame type field (labeled or not), and the label field. A switch port that receives frames via this kind of radio link can identify the virtual network to which each frame belongs only by applying predefined rules. If a radio access point were connected by radio simultaneously to two mobile terminals belonging to two different virtual networks, the port of the switch to which that access point were connected would constantly modify the virtual network to which that port belonged. At certain times, the switch would therefore be incapable of transmitting frames to a given mobile terminal belonging to a virtual network other than that to which the port is assigned at the time in question.

IETF Request For Comments RFC 2002 describes a method called the mobile Internet method that solves this problem because it enables a terminal to be contacted using its home Internet address. This prior art method has the disadvantage of introducing a latency time, which is non-negligible for some services, on the occasion of each change of subnetwork consequent upon a change of radio access point. Each terminal much register with the router of the visited subnetwork and the router of the home subnetwork. The method further necessitates the use of routers and wireless terminals constructed specifically to apply the method.

### OBJECT AND SUMMARY OF THE INVENTION

The object of the invention is to remedy these drawbacks.

The invention firstly provides a method enabling mobility of a wireless terminal in a local network conforming to the IEEE 802.1Q standard, said network including:

radio access points transparent for frames conforming to the IEEE 802.1Q standard;

mobile terminals belonging to a plurality of virtual networks and each having an Internet address;

at least one switch and at least one router, all the switches being configured to operate in virtual networks using Internet addresses; the method consisting in:

configuring in accordance with the IEEE 802.1Q standard:

all switch ports that are connected to radio access points;

each switch port that is used for a switch-switch or switch-router connection; and

the interface of each router connected to a switch;

configuring all the switches to operate in virtual networks using Internet addresses;

setting up a link between the local area network and a mobile terminal via a switch port and via a radio access point connected to said port; and

writing a virtual network identifier in accordance with the IEEE 802.1Q standard in the header of each frame sent by said terminal to the local area network.

Accordingly, when a frame sent by a wireless terminal reaches the port of a switch, it is always labeled explicitly with a virtual network identifier. Because the port has been configured in accordance with the IEEE 802.1Q standard, it reads the label and therefore has no problem determining exactly which virtual network each frame belongs to, even though the frames are received from different virtual networks.

If that port must send a frame to a wireless terminal, it has no problem accepting the frame, regardless of the virtual network to which it belongs, because it is configured in accordance with the IEEE 802.1Q standard.

The invention secondly provides a radio interface device for a wireless terminal for using said terminal in a local area network conforming to the IEEE 802.1Q standard, said network including a plurality of terminals respectively belonging to a plurality of virtual networks, said terminals each having an Internet address; wherein said interface includes means for writing a virtual network identifier in the header of each frame sent by said terminal to the network.

### BRIEF DESCRIPTION OF THE DRAWINGS

The invention will be better understood and other features of the invention will become apparent from the following description and the accompanying drawings:

FIG. 1 (described above) shows diagrammatically one example of a prior art local area network in which two virtual local area networks are distinguished by the Internet addresses of the terminals.

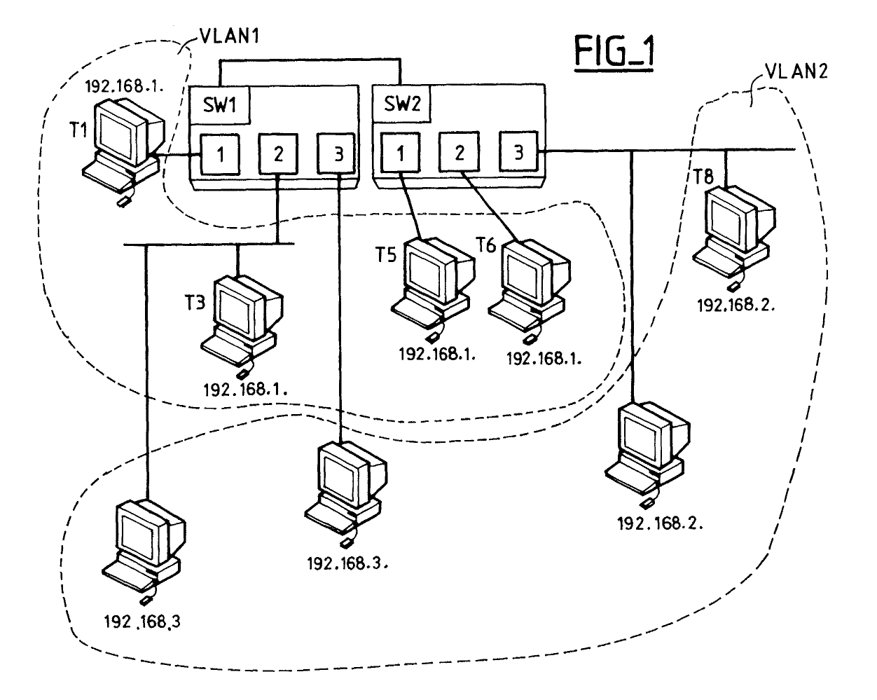

FIG. 2 shows diagrammatically one example of a local area network using the method according to the invention.

FIG. 3 shows diagrammatically one example of a wireless terminal incorporating a radio interface device according to the invention.

### MORE DETAILED DESCRIPTION

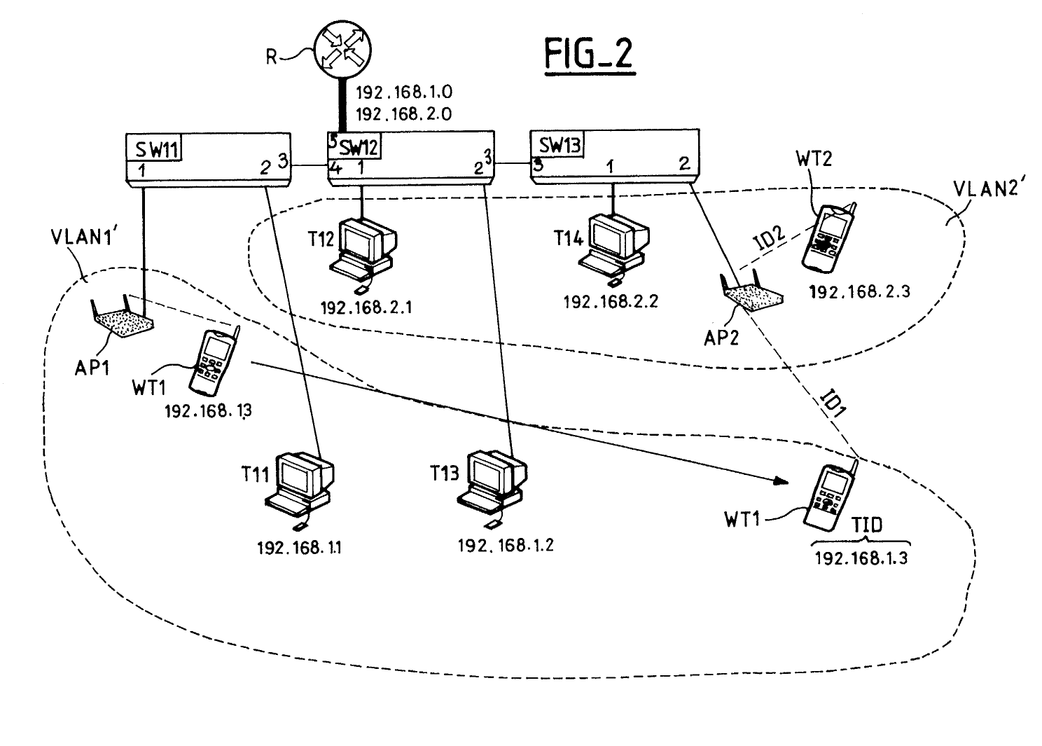

The network shown by way of example in FIG. 2 includes:

a router R connected to an Ethernet switch SW12 which is in turn connected to two Ethernet switches SW11 and SW13; the router enables terminals to communicate using their Internet addresses;

a radio access point AP1 connected to the port 1 of the switch SW11;

a wired terminal T11 connected to the port 2 of the switch SW11;

a wired terminal T12 connected to the port 1 of the switch SW12;

a wired terminal T13 connected to the port 2 of the switch SW12;

a wired terminal T14 connected to the port 1 of the switch SW13;

a radio access point AP2 connected to the port 2 of the switch SW13; and

two multifunction wireless terminals WT1 and WT2 (for example providing mobile telephone and personal digital assistant functions).

The switches SW11, SW12, SW13 are configured to operate in virtual networks defined by Internet addresses.

The port 1 of the switch SW11 and the port 2 of the switch SW13, which are respectively connected to the radio access points AP1 and AP2, are configured in accordance with the IEEE 802.1Q standard.

A port 3 of the switch SW11 is connected to a port 4 of the switch SW12. A port 3 of the switch SW12 is connected to a port 3 of the switch SW13. A port 5 of the switch SW12 is connected to a port of the router R. All the ports used for the connections between switches are configured in accordance with the IEEE 802.1Q standard. The port of the switch SW12 and the interface of the router R that are connected are also configured in accordance with the IEEE 802.1Q standard, in other words the frames are labeled with a virtual network identifier.

The radio access points AP1 and AP2 are conventional but are chosen from those that are transparent to frames conforming to the IEEE 802.1Q standard.

In this example, the rules of belonging to a virtual network are as follows. A virtual network VLAN′ is identified by the binary word 192.168.1 contained in the first three bytes of the Internet address of each of the terminals WT1, T11, T13. A virtual network VLAN2′ is identified by the binary word 192.168.2 contained in the first three bytes of the Internet address of each of the terminals T12, T14, WT2. The Internet addresses of the terminals differ from each other in the fourth and final byte. For example, the terminal WT1 has an Internet address TID equal to 192.168.1.3 in which the field 192.168.1 shows a frame belongs to the virtual network VLAN1′ if that frame is not labeled with the identifier ID1 of that virtual network.

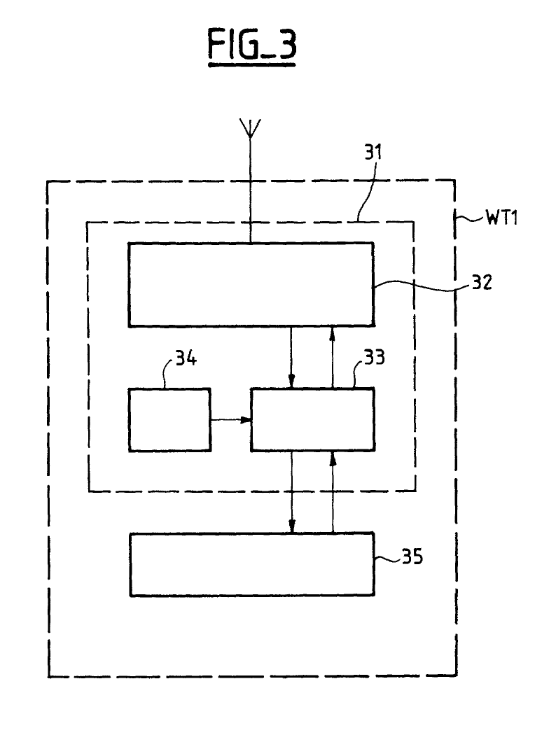

FIG. 3 shows the block diagram of a wireless terminal WT1, for example, including a radio interface device 31 according to the invention and a data processor circuit 35. The device 31 includes:

a circuit 32 for sending/receiving radio frames,

a circuit 33 for composing/decomposing Ethernet frames, and

a circuit 34 for storing a virtual network identifier.

The circuit 33 writes in the label field of an Ethernet frame the identifier ID1 specific to the virtual network VLAN1′ to which the terminal WT1 belongs. The virtual network identifier is a number on 12 bits conforming to the IEEE 802.1Q standard. The circuit 33 is interleaved between the data processor circuit 35 and the circuit 32 for sending/receiving radio frames. The circuit 33 supplies the circuit 32 with the Ethernet frames to be sent and the circuit 32 supplies the circuit 33 with Ethernet frames received. The data processor circuit 35 supplies the Ethernet frame composition/decomposition circuit 33 with Internet packets to be sent. The circuit 33 supplies the circuit 35 with Internet packets received.

The circuit 34 for storing a virtual network identifier can be implemented in either of two variants:

If the virtual network identifier is fixed, the circuit 34 can consist of a device for storing an identifier that a network administrator enters via a keyboard, for example, to configure the radio interface of the terminal manually.

If the virtual network identifier changes frequently (for example if the Internet addresses are assigned dynamically), the circuit 34 can consist of software for automatically determining an identifier as a function of the Internet address of the terminal and in accordance with rules of belonging to a virtual network.

If a frame reaches a port of a switch SW11, SW12, SW13 and if that port is not configured in accordance with the IEEE 802.1Q standard, the port applies rules for determining the virtual network to which it belongs based on the home Internet address of the frame. For example, the port 1 of the switch SW13 extracts from the Internet address 192.168.2.2 of the terminal T14 the field 192.168.2 and deduces from it that the frame belongs to the virtual network VLAN2′ because that field satisfies the rule for belonging to the virtual network VLAN2′.

For the mobile terminals, such as the terminals WT1 and WT2, the Ethernet frames are labeled and then encapsulated in radio frames created by the radio interface devices of the terminals. If an Ethernet frame reaches the port 2 of the switch SW13 it is therefore always labeled with a virtual network identifier. The frame includes a label ID1 if it comes from the terminal WT1 or a label ID2 if it comes from the terminal WT2. The switch SW13 can therefore tell directly and with certainty the virtual network to which the frame belongs.

Assume that the terminal WT1 is moving while it is communicating via the radio access point AP1. It leaves the area covered by the radio access point AP1 associated with the switch SW11 and enters the area covered by the radio access point AP2 associated with the switch SW13, which is different from the switch SW11. It is assumed that the old and new radio access points used belong the same physical subnetwork, that is to say are connected directly or via switches to the same router.

The terminal WT1 still belongs to the virtual network VLAN1′ because it sends Ethernet frames (encapsulated in radio frames) whose headers always contain the same virtual network identifier ID1 and because the port 2 of the switch SW13 is configured in accordance with the IEEE 802.1Q standard.

In this example, the wireless terminals incorporate a radio network interface device according to the invention. In other examples, such as portable personal computers, the radio network interface device is a removal network card plugged into a port of the terminal.

Using the method according to the invention has the following advantages:

It re-uses existing Ethernet switches able to support virtual networks identified by Internet addresses.

The mobile terminals can keep the same Internet address at all times. The terminals can have different subnetwork addresses within the same physical subnetwork.

The broadcast domains coincide with the virtual networks.

1. A method enabling mobility of a wireless terminal in a local network conforming to the IEEE 802.1Q standard, said network including:
radio access points transparent for frames conforming to the IEEE 802.1Q standard;
mobile terminals belonging to a plurality of virtual networks and each having an Internet address;
at least one switch and at least one router, all the switches being configured to operate in virtual networks using Internet addresses; the method consisting in:
configuring in accordance with the IEEE 802.1Q standard:
all switch ports that are connected to radio access points;
each switch port that is used for a switch-switch or switch-router connection; and
the interface of each router connected to a switch;
setting up a link between the local area network and a mobile terminal via a switch port and via a radio access point connected to said port; and
writing a virtual network identifier in accordance with the IEEE 802.1Q standard in the header of each frame sent by said mobile terminal to the local area network.

2. A radio interface device for a wireless terminal for using said terminal in a local area network conforming to the IEEE 802.1Q standard, said network including a plurality of terminals respectively belonging to a plurality of virtual networks, said terminals each having an Internet address;
wherein said interface includes means for writing a virtual network identifier in the header of each frame sent by said terminal to the network.

3. A device according to claim 2, wherein the means for writing in the header include means for storing a fixed identifier.

4. A device according to claim 2, wherein the means for writing in the header include means for determining an identifier as a function of the Internet address of the terminal and in accordance with the rules of belonging to a virtual network.
